(19) United States
(12) Patent Application Publication
(10) Pub. No.: US 2020/0042615 A1
(43) Pub. Date: Feb. 6, 2020

(54) Talmud and the blockchain

(71) Applicant: Wesley John Boudville, Perth (AU)

(72) Inventor: Wesley John Boudville, Perth (AU)

(21) Appl. No.: 15/998,314

(22) Filed: Aug. 6, 2018

(51) Int. Cl. G06F 17/30

(52) U.S. Cl. CPC G06F 17/30117; G06F 17/30185; G06F 17/30194

(57) ABSTRACT

An immutable blockchain has bad records. A record author writes a later record with commands, for programs reading the blockchain. A command is “delete”, to delete the bad record. Another is “replace”, to replace the record with data from the command record. Another is “append”. A command can have chaincode. Commands filter records to make an altered copy of the blockchain in memory. Records can comment and operate on records written by other authors.

### TECHNICAL FIELD

Handling errors in a blockchain.

### BACKGROUND

Blockchains and cryptocurrencies have become widely known recently, especially after the large price gains of Bitcoin in 2017. A blockchain uses a distributed ledger, held at various nodes of the blockchain. Nodes are located at different locations and a popular blockchain could have nodes spread globally.

The ledger is often called “immutable”. Strictly, this is erroneous. The ledger is more correctly described as append-only, meaning that new data can be added to the end of the ledger, but existing data in the ledger cannot be altered.

Many startups promoted the idea that a blockchain can be used to verify or authenticate data written to it.

### BRIEF DESCRIPTION OF THE DRAWINGS

FIG. 1 shows a user sending false data to a blockchain.

FIG. 2 shows a filter that tests data sent to a blockchain.

FIG. 3 is the prior art of the Talmud.

FIG. 4 shows a record deleting an earlier record.

FIG. 5 shows a record replacing an earlier record.

FIG. 6 shows a record deleting an earlier deletion.

FIG. 7 shows 2 deletions deleting the same earlier record.

FIG. 8 shows a record deleting 2 earlier records.

FIG. 9 shows a record being appended to an earlier record.

FIG. 10 shows a record with chaincode to operate on an earlier record.

FIG. 11 shows chaincode in a blockchain and outside the blockchain.

FIG. 12 shows ACME sending goods via ABC trucks.

FIG. 13 shows a record deleting an earlier record signed by 2 firms.

FIG. 14 shows a blockchain and 2 sidechains.

FIG. 15 shows a sidechain common to 2 blockchains.

### DETAILED DESCRIPTION OF THE PREFERRED EMBODIMENT

What we claim as new and desire to secure by letters patent is set forth in the following claims.

We define some terminology. We will say a blockchain can be or is immutable if the only way it can be altered is by appending new data. This conforms to standard industry usage.

We will use “record” to refer to the “block” of a blockchain. We will use “immutable” (instead of “read only”) largely to conform to industry usage.

This submission has the following sections.

1: Basic problem;

1.a: No consensys;

2: Commands delete and replace;

3: Commands append and prepend;

4: Forward referencing;

5: Chaincode;

6: 2 firms signing a record;

7: Referring to another author's record;

8: Sidechain;

9: Blockchain policies;

10: Rewritable blockchain;

1: Basic Problem;

There is a widespread misperception about blockchains, that if data is in a blockchain it is correct. In other words, the blockchain legitimises or validates any data present in it. In general this is wrong. Suppose a blockchain makes and uses a coin (cryptocurrency) to incent the operators of the nodes to run their node hardware. The Bitcoin blockchain is the best known case. This blockchain is a computational universe which makes and validates the coin. Similar remarks can be made for other coin blockchains like Ripple, Ethereum, Litecoin and Monero. When these rose in price massively in 2017, many in the public made a wrong understanding that data written to records (blocks) in those and other blockchains was also validated.

Instead, when data is written to a blockchain, usually the only thing the blockchain validates about that data is that it was written by a specific entity (user) at the time given by the timestamp in the record. The blockchain does not attest to the intrinsic veracity of the data. The attesting of the identity of the user can be done by private key encryption. The user could sign the data with its private key. Later, a program analysing the blockchain could verify the signature against the published public key.

(Some blockchains might not even do this, in the purported interest of strong user anonymity.)

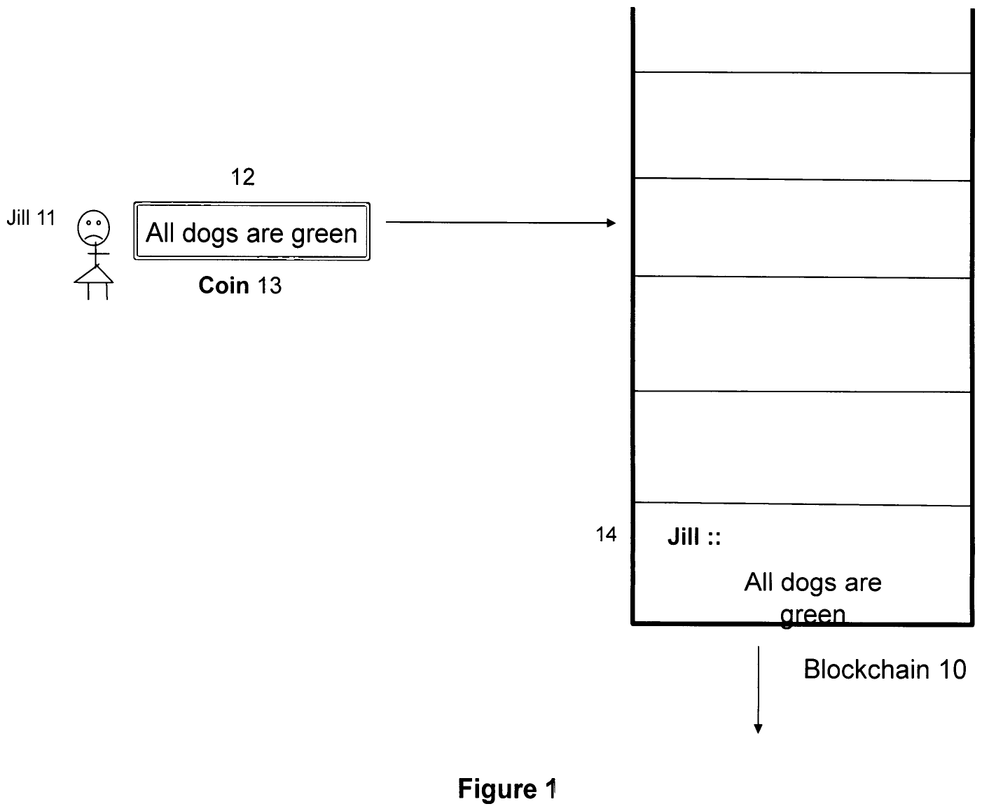

FIG. 1 shows false data being written to blockchain 10. Time flows from top to bottom. New records are appended at the bottom. Jill 11 sends data item 12. It consists of the statement “All dogs are green” and is accompanied by Coin 13. The latter is payment of a certain quantity of the coin used by the blockchain, in order for the statement to be written to it. Not all blockchains use coins, but for the purpose of illustration, we assume that this blockchain does. The figure shows the statement being accepted and appended to the blockchain in record 14. The record also shows “Jill” as a designator of the author of the statement. In practice, the string “Jill” could be replaced by a cryptographic signature of hers.

This is a fundamental point. A blockchain has no intrinsic way to verify data offered to it. We hope the reader will understand that “All dogs are green” is a false statement.

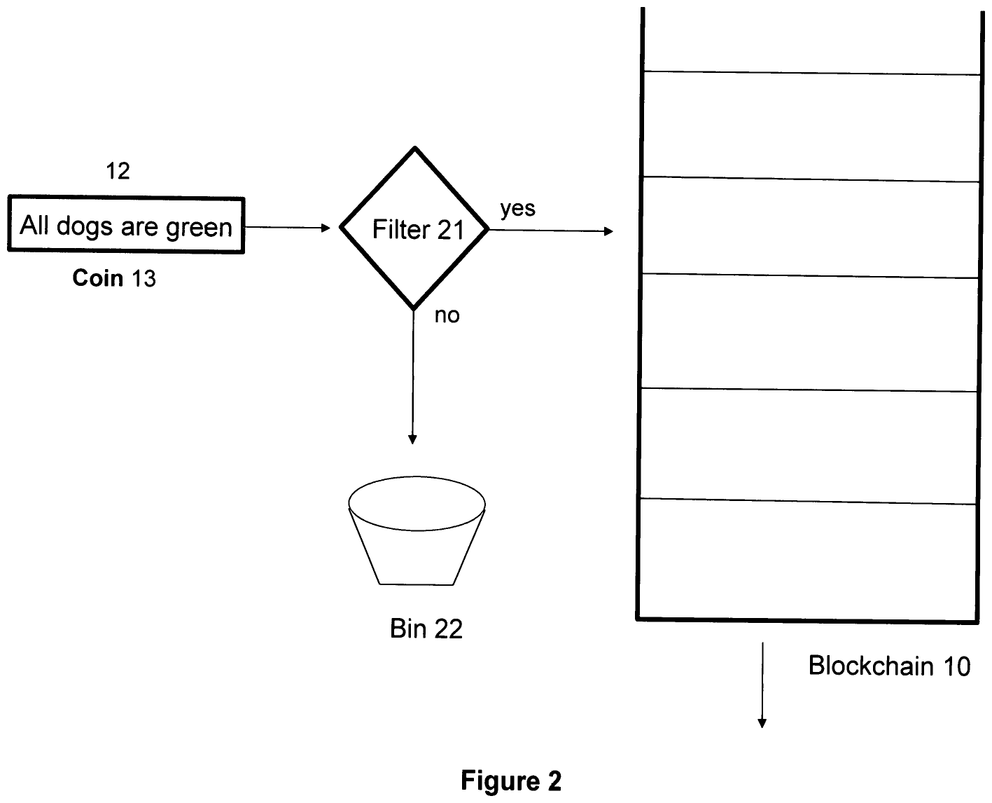

One answer is to interpose a filter between the user and the blockchain. In FIG. 2, Filter 21 is some type of computational engine, perhaps or probably with access to external databases. It tries to verify the data according to some rules (heuristics). If the data does not pass the test, it is rejected and sent to Bin 22.

FIG. 2 can have elaborations. For example, the filter could find a score between 0 and 1 for submitted data. Zero means reject, one means accept. But the range is a fuzzy logic result. There could be a range, say [0.2, 0.9] where a data in this range can be accepted by the blockchain if the user pays an extra amount of coin. Whereas if the data is in (0.9, 1], only the default lesser amount is levied because the data is considered more reliable.

Or for data in the range between [0.2, 0.9], the extra amount levied is a function of where the data result is in that range. Perhaps the extra amount is a maximum at 0.2 and falls monotonically to 0 at 0.9. The latter means that only the default amount is levied.

The filter could use Machine Learning or Artificial Intelligence or neural networks or other means.

1.a: No Consensys;

It should be made clear that the problem tackled by this application is not solvable by any sort of consensys mechanism. Consensys refers to methods used in public blockchains to guard against bad nodes deliberately introducing false data. Those are voting mechanisms. Consensys is about determining what is to be appended to the blockchain. To PREVENT bad data going into the blockchain.

The present problem is essentially where records are written by authorised users, where the data is later found to be wrong. The “damage” to the blockchain has been done. The most common case can be where the determination of data being wrong is made by the person or firm that wrote the data. An innocent mistake. Though there can also be cases where the bad data was deliberately written as such to the blockchain.

2: Commands Delete and Replace;

FIG. 2 still has a problem. It must be expected that in real world uses of a blockchain, data will still be written to the blockchain that other people will afterwards consider to be wrong. How to handle this?

In fairness, many people working in blockchain startup firms are aware of this problem. But in public statements and webpages extolling the virtues of blockchains, there is remarkably little discussion of the problem.

One answer is to make the blockchain rewritable. For example, Ateniese et al in U.S. patent application “Distributed key secret for rewritable blockchain”, Ser. No. 15/684,721. Or “Rewritable blockchain” by the same authors, Ser. No. 15/596,932.

Our application preserves immutability of records already in the blockchain. (At least till Section 10.) We start from the above observation that a record is not considered verified. We also note that any use of a blockchain by an analyst involves hardware and software that sit between the blockchain and the analyst. At the most basic level this must be so. The data is stored in tape or computer memory at densities too small to be seen by the naked eye. Some combination of hardware and software interposes between the stored blockchain and the human analyst.

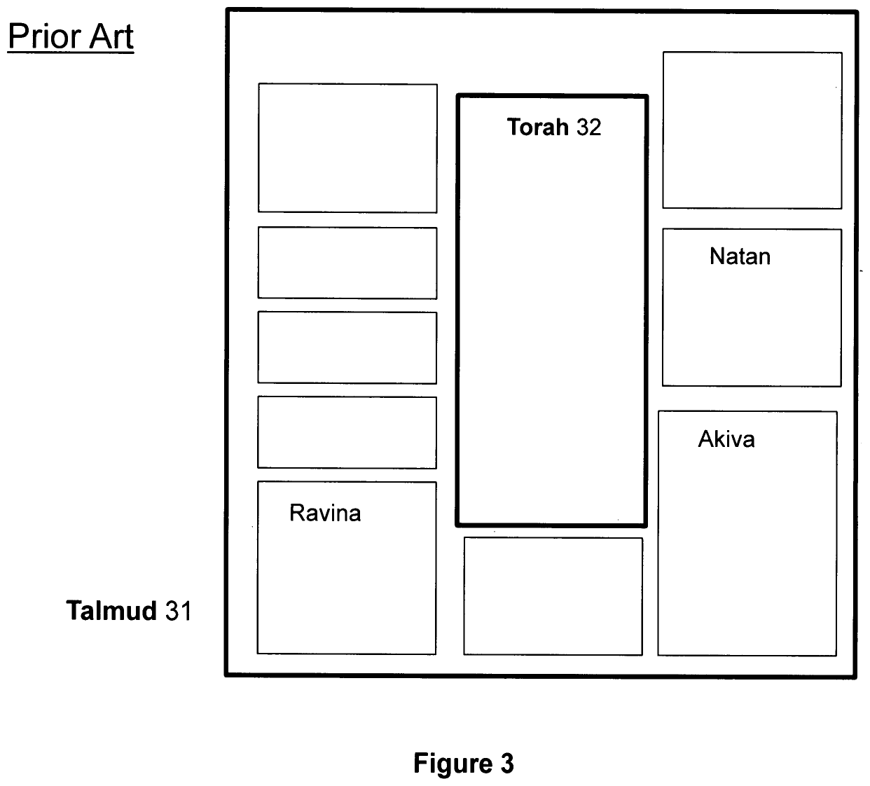

The prior art is FIG. 3. Item 31 is a schematic of a page from the Talmud. Its core is item 32, a passage from the Torah. Various sections placed around 32 are commentaries made by Jewish scholars across centuries about item 31 or about earlier remarks by others. One aspect in common with a blockchain is that entries are immutable. A second is that new entries can be written.

The key inspiration for this application is the observation that the Talmud commentaries refer to or reinterpret or explain earlier entries.

We treat the case of blockchains where the author of a record can be identified. By this we do not necessarily mean the person's legal name and government issued identifier (like a driver's license or passport id). As above, it could be that a person can prove, perhaps via her public and private keys, that she wrote a given record to the blockchain, where that record is now considered wrong.

Blockchains can also be classified as permissioned (sometimes called private) or permissionless (sometimes called public). The latter are blockchains where anyone can run a node. These include most blockchains using cryptocurrencies. The former blockchains are where the identities of who runs every node are known. In practice, a permissioned blockchain is controlled by a few parties. Usually major firms at the head of supply chains. Such a firm would mandate that its suppliers and their suppliers (etc) run nodes in the blockchain. No cryptocurrencies might be used. A firm running a node would bears the cost of the hardware and the running as part of doing business.

Consider a person Jill who works at a firm in a permissioned network. She writes a record. In general, the record will show that her firm “Acme Parts” (say) wrote the record. It might also show an identifier of her, though not necessarily her real name.

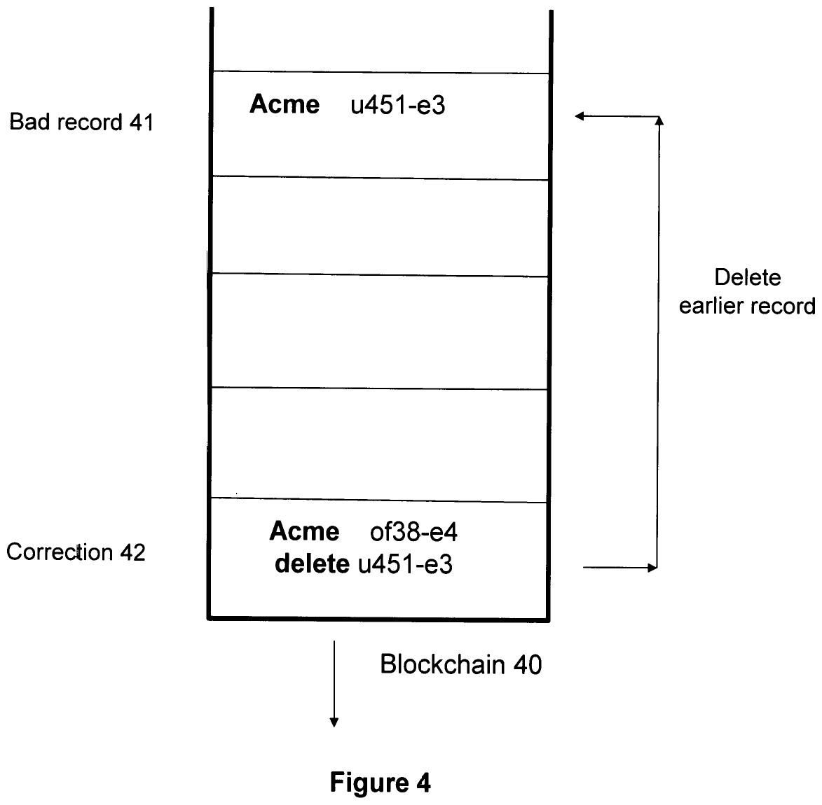

After she wrote the record, she realised she made an error. We can assume that she used a program that tested what she originally wrote for values valid within certain ranges. But within those ranges, she wrote a value later found to be wrong. The record with the wrong value is now in the blockchain. See FIG. 4. Blockchain 40 has Bad record 41. The latter has a unique id u451-e3. This id should be unique at least within all the records thus far written by Acme. It might also be unique within all records that can ever be written by Acme.

Other firms also write to Blockchain 40. The unique id might be unique across all firms. One possibility is to use the timestamp written by the blockchain in each record. For the (expected to be rare) case of 2 firms writing records with the same timestamp, there could be an extra parameter that lets a record be id′d as unique. Perhaps a field designating the firm who wrote the record.

After Jill and Acme wrote Bad record 41, she realised and wrote record Correction 42. It has its unique id. And it has a command “delete u451-e3”. This references the earlier Bad record 41. It is an instruction to an analysis program later run, to disregard record u451-e3. It is not a literal delete of a blockchain record, because the blockchain is immutable. But we use the term delete as the most natural description of the operation.

Other terms might be used for this command, like “ignore” or “skip”. Because of the read-only feature of blockchains, some readers could prefer these terms.

Note that in FIG. 4, the example records 41 and 42 show “Acme”. They might just show another identifier that can be mapped to Acme by the analysis program. The latter might have a list of all firms that can write to the blockchain, and their ids. Also, the “delete” string in Correction 42 can be replaced by a command id, where the analysis program has a list of all commands and their ids. So “delete” can be represented by the integer 1, and other commands by other integers.

This is akin to the relationship between assembly language and machine language. The “delete” would be “in” assembly language, while the “1” would be “in” machine language. An analogy to aid the reader.

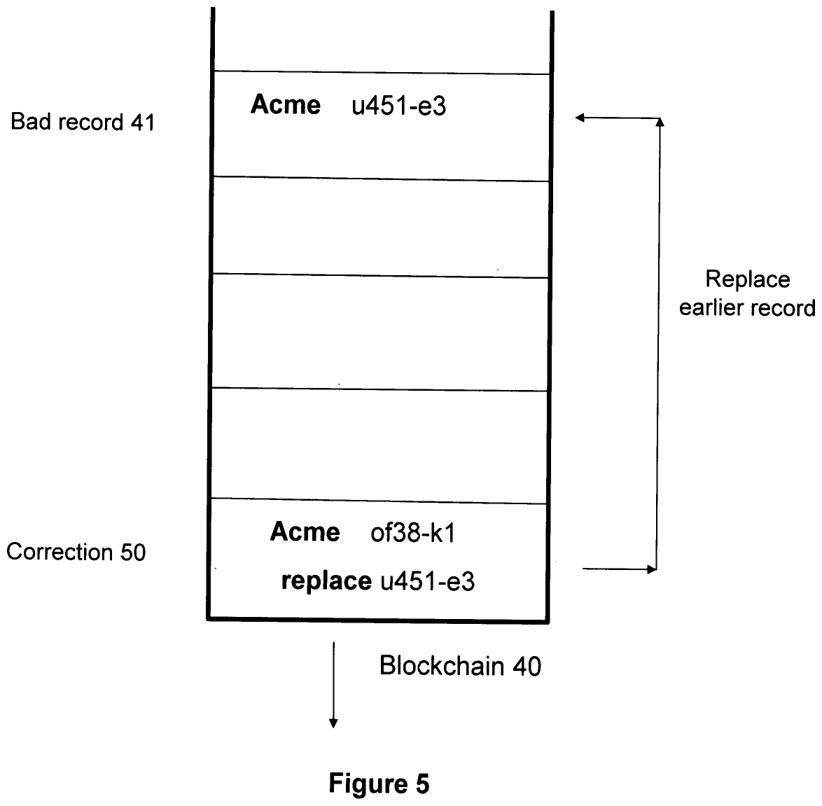

The record Correction 42 can be imagined as being essentially empty of other data. Or see FIG. 5. Instead of Correction 42 there is Correction 50. This has a command replace. The record also has other data, to be used in place of the data in Bad record 41.

There are 2 possibilities when a replace is done. Suppose Bad record 41 was written on 1 Feb. 2018 at 11:00 UT, while the replace record was written on 2 Februrary 2018 at 10:00 UT. For the data in the replace record, which time stamp should be used? By default, it could be the time stamp of the earlier record. But there could be cases where the time stamp of the replace record is used. There might be an argument to the replace to pick the latter, whereas if the argument is omitted, the default of using the earlier time is done.

Thus we have a syntax of commands {delete, replace}.

The previous examples used cases of an absolute id of a record being used as an argument to the command. An alternative is to use a relative id. So a delete might be (eg) “delete #1”, where the “#1” means delete the the previous record written by the author of the delete command. Between the current record with the command and the referenced record might be records written by other entities. Another case is where a firm has several employees that can write to the blockchain. So there might be a notation that says “delete %1”, where this means delete the previous record written by (anyone in) this firm.

There might be notation to delete a record written by a given employee. Eg. “delete #1 by Jill”, which means delete the previous record written by employee Jill. Here “Jill” could be represented by some type of employee id of hers, or some signature of hers.

There could be notation to delete a range of records. Eg. “delete #21-30” means delete the previous twenty first to thirtieth records inclusive written by the author of this command. In extremis, there might be eg. “delete * by Jill” which means delete all records written by employee Jill. This allows for a more compact notation than having to specify every command (in relative or absolute terms) written by her.

The syntax of commands could let both relative and absolute references to commands be used, though almost certainly not both in any given use of a command.

Now suppose there is an analysis program that uses the blockchain as input. It might be used to audit the tracking of goods sent in a supply chain. It could also audit any payment amounts written in the records. A crude use of the program would be for it to start at the earlier record and parse the blockchain, moving forward in time.

How to handle records with instructions like delete and replace? This problem was solved decades ago with compilers that take computer source code files and make executables. A source code file is a linear ordering of its data, like a blockchain. The compiler would several passes thru the source code. An early pass, perhaps the first, would parse the code and find variables defined by the programmer. These are put into a symbol table to be used in later passes. Ditto for blockchain. An analysis program makes a first pass. This can be from the 0-th (earliest) record or the latest. It finds records with commands. It stores these, or pointers to them, in working memory in an area called “Commands”. It makes a second pass. Likely this pass can be from the earliest record. When it comes to a record, it checks if the record is referred to in any Commands entry. If so, that command is run.

If the command says delete, the program skips the current record. If the command says replace, the program replaces the current record in its memory with the data in the command record.

There can be elaborations. For example, consider the Commands. If there are many, a hashtable can be made. The keys are the record ids in the Commands. The values are the corresponding command records in the Commands. Then when a given record is being read and the program wants to see if any command in Commands refers to it, the program compares the record id against the hashtable.

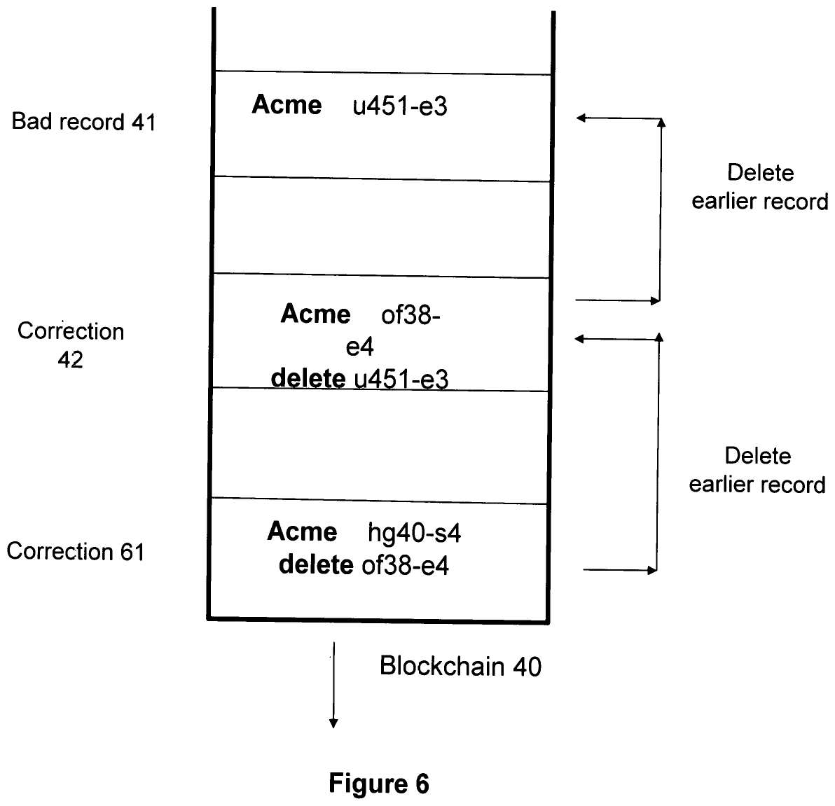

In the blockchain, another issue is where commands are compounded. See FIG. 6. It shows Jill writing 2 delete commands. Correction 61 deletes Correction 42. An analysis program can choose to interpret this as the more recent command countermanding the earlier deletion. So the original record u451-e3 is retained.

Hence a policy could be that commands are executed starting with the most recent and going back in time. One nuance is this policy could be imposed as a default policy by the blockchain. But the blockchain could let individual firms have their own policy.

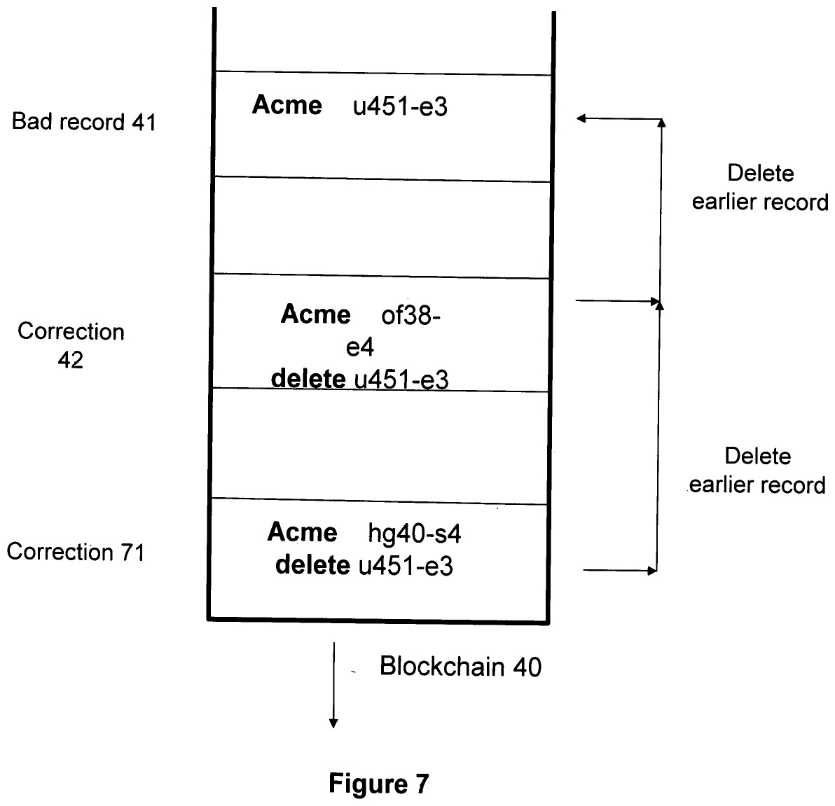

One issue is shown in FIG. 7. Jill writes 2 delete commands. But Correction 71 deletes the same record as Correction 42. This is known as an idempotent operation. If such an operation is repeated twice or more, it has no material difference.

So far, we discussed an author of a record writing later records that operate on it. This is important because the author, or another person from the same firm, would have standing (authority) to do it. The analysis program might ignore a delete or replace record if it comes from a different firm.

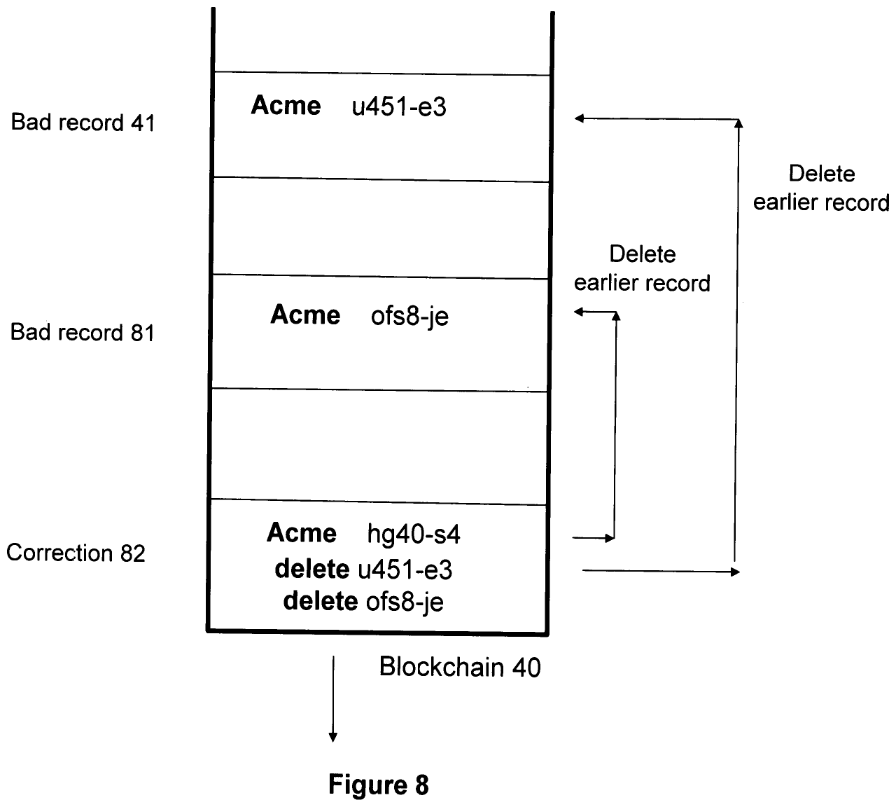

A given command record can have several commands. See FIG. 8. It shows a record Correction 82 that has 2 delete commands. One deletes Bad record 41. The other deletes Bad record 81. Why would a record have several commands? It might be more efficient. A record likely has overhead in terms of the timestamp and other fields directly under the control of the blockchain. If a command is short, it might be more efficient from a storage perspective to put it and other commands into the same record.

This could also be useful if the author or firm has to pay the blockchain to write a record. Money (in whatever form) can be saved by writing several commands into a single record.

Another case is where a command record has a delete command and a replace command, where these refer to different earlier records. For simplicity, no figure is given for this case. The parties governing the blockchain can define a standard format and syntax of the commands, to be used by all firms running nodes.

3: Commands Append and Prepend;

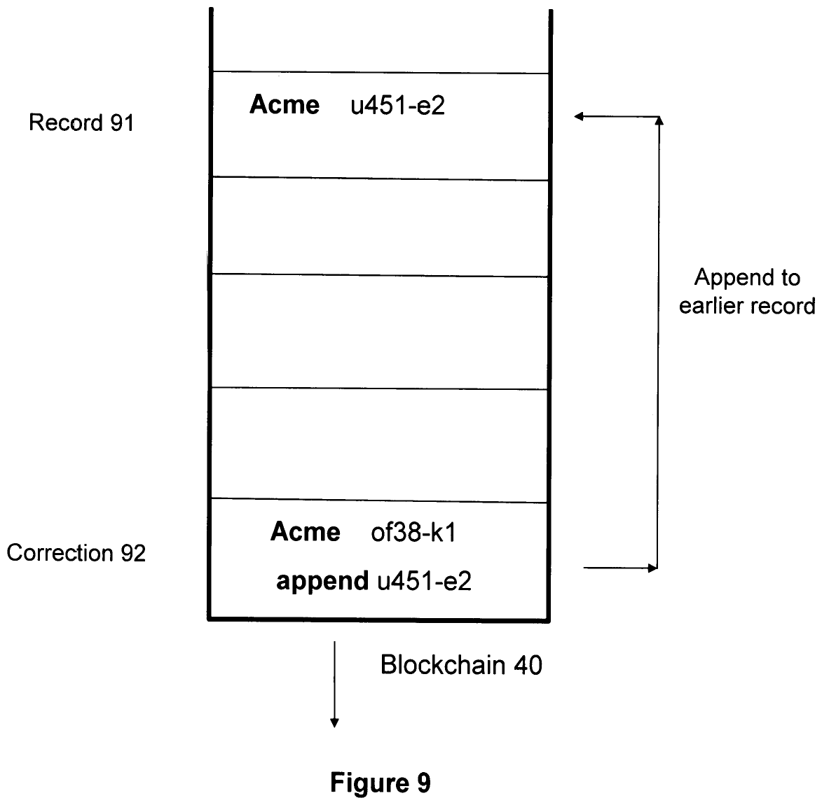

Another command can be “append”. This means take whatever data is in this record (the record containing append), excluding the append command itself, and append the data to the record whose id is given here. See FIG. 9. It shows Record 91 and record Correction 92. The latter has a command “append” which points to Record 91. Correction 92 has data (not shown) which is to be appended to the data of Record 91.

By default, the combined data has the time stamp of Record 91. But there can be an option for the combined data to have the time stamp of Correction 92. The option can be expressed as a parameter to the append command.

Another option could be “prepend”. Take whatever data is in this record (the record containing the prepend command), and prepend the data to the record whose id is given here.

4: Forward Referencing;

Thus far the examples of command records have referred to earlier records in the blockchain. There could also be cases where a command record can refer to a record not yet written. It might refer to an id. Then if or when such a record is written, during the writing of such a record, the blockchain engine can apply the command in the earlier record.

One command could be “append”. To append the data in the command record to the future record. There can be options to decide which time stamp to associate with the modified future record.

Another command could be “prepend”. To prepend the data in the command record to the future record. There can be options to decide which time stamp to associate with the modified future record.

One reason can be that data set Alpha is made at a first time. Perhaps collected from some sources. Alpha is incomplete. For it to be used, data (“Beta”) from other sources needs to be collected. But perhaps the machine that collected Alpha wants to store it in the blockchain, as a precaution against hardware or network or power failure, instead of waiting for Beta to be collected. So Alpha is written to the blockchain. With a command that Alpha is to be used with data in a future record.

5: Chaincode;

Suppose Jill wrote Bad record 41 as in FIG. 4. But she can correct it not by deleting it entirely, but by making changes. One method is to write another record, containing “chaincode”. This is code written in some computer language, that can be run against records in the blockchain. In this example, chaincode is run on Bad record 41, to alter its contents in computer memory and then to use the altered data in place of Bad record 41 when doing further analysis.

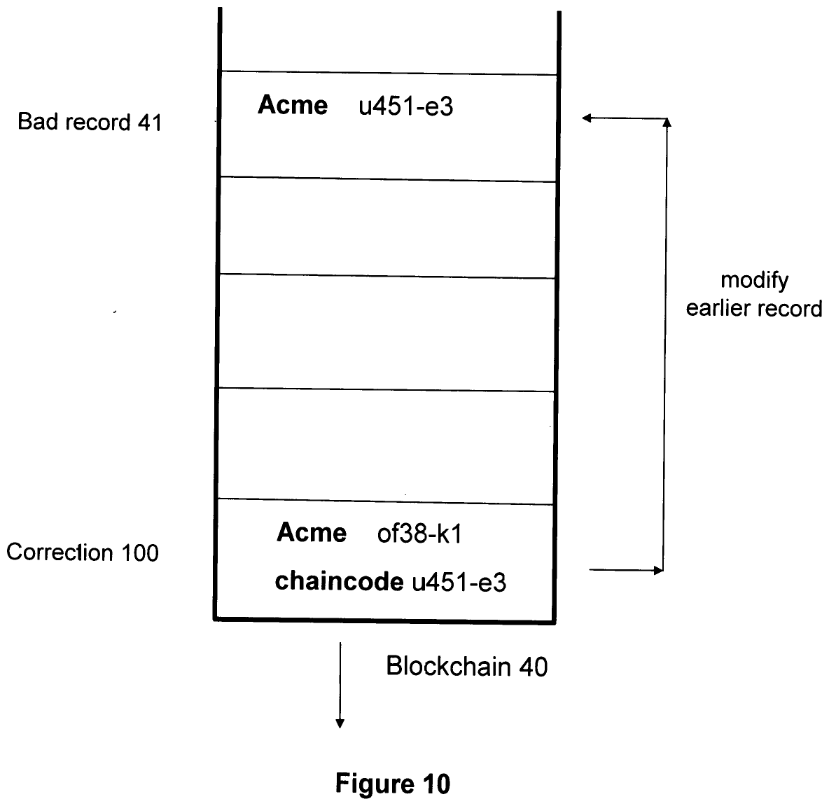

See FIG. 10. It shows record Correction 100 containing chaincode that operates on the contents of Bad record 41.

The Correction 100 record might itself be stored in the output blockchain, or not. The decision might be given by an option flag in item 100. It could be overridden by a policy setting of the analysis program, which could decide whether to write the chaincode or not to the output blockchain.

Instead of the chaincode having the id of a single previous record, it could have the ids of several records. Or the chaincode could have a range of times. Meaning that it is applied to records from a given firm, written in that time interval.

As a clarification of terminology—chaincode is often currently used as synonymous with “smart contact”, to decide when to write a record to a blockchain, or to analyse existing records. We use it to define code written into a record itself, to analyse or alter other records when those records are read from the blockchain.

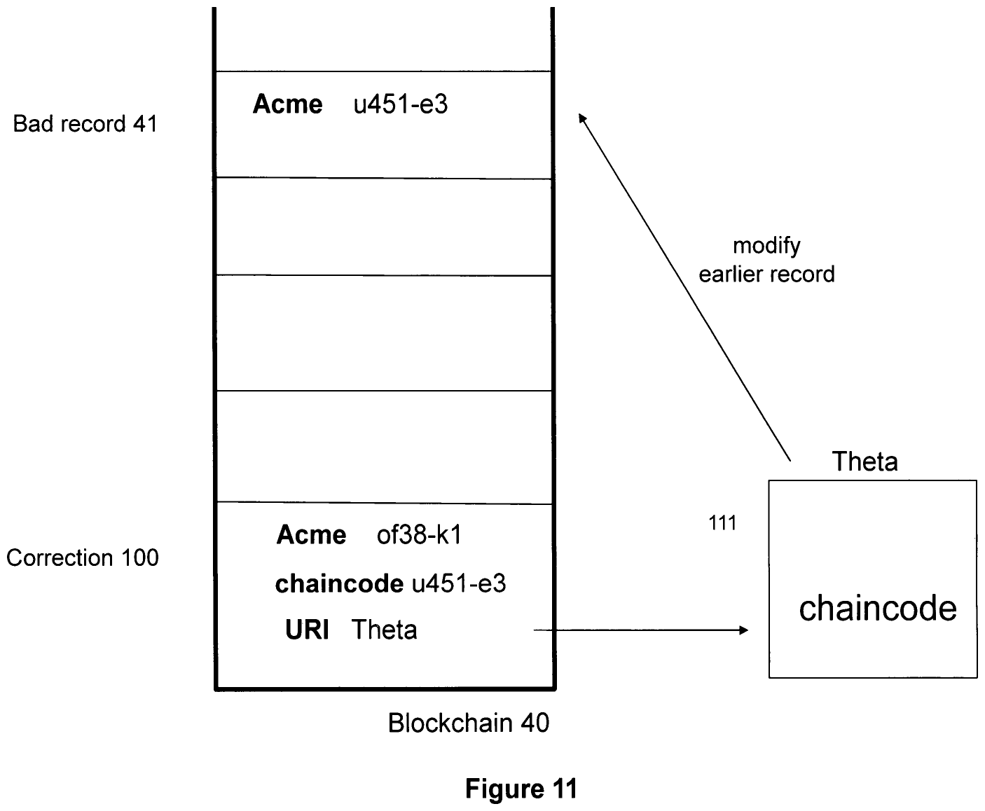

A variant is possible. See FIG. 11. Record 100 can have a parameter Theta, which might be a URI (Universal Resource Indicator). This points to item 111, at the address Theta on a computer network. Theta has chaincode which can then be run to alter a copy of Bad Record 41 in memory. Record 100 might have chaincode exor Theta has chaincode. Or there could be chaincode in 100 and Theta, that is combined in some manner and run on Bad Record 41.

If chaincode exists in 100 and Theta, they might be written in different computer languages, and compiled and run separately. If they are in the same language, one option is that both are merged into 1 file and then compiled and run. Or both might be compiled and run separately.

6: 2 Firms Signing a Record;

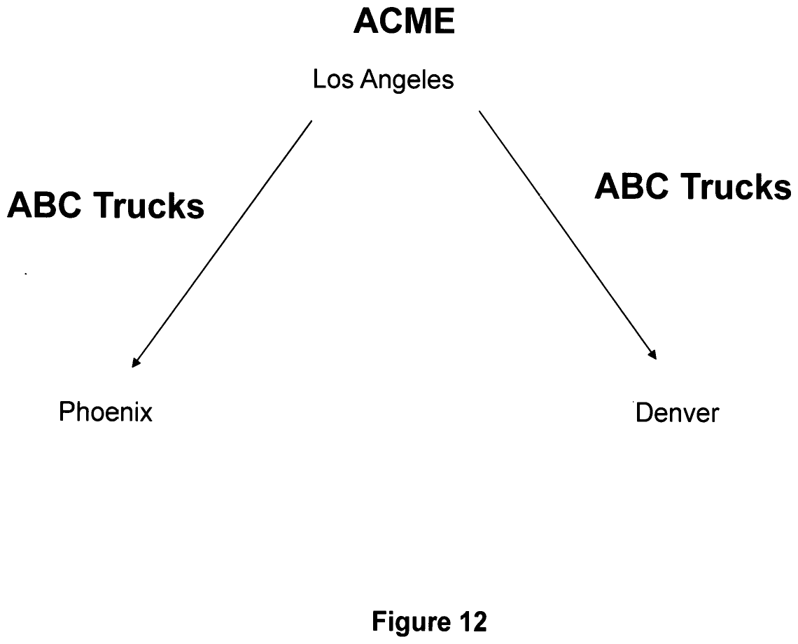

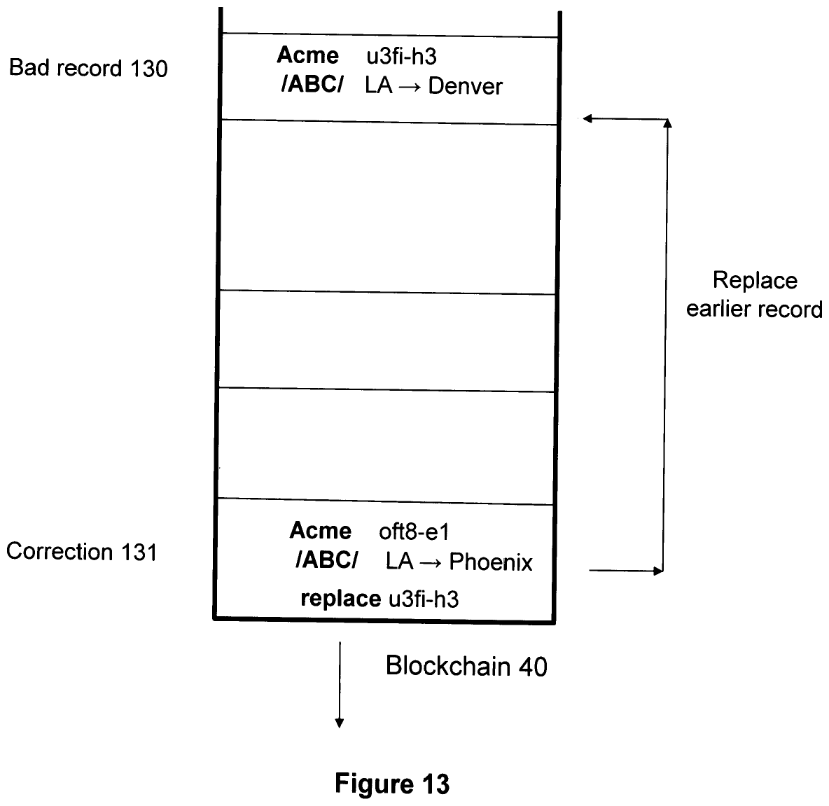

Previously we considered cases where a firm wrote a record to the blockchain. Here we look at a case where a record also has a signature of another firm. See FIG. 12. It shows firm Acme shipping a payload via ABC Trucks. Acme is in Los Angeles. The payload goes to Phoenix. But for whatever reason there was a mixup. When the ABC truck driver arrived at Acme's office in Los Angeles, the manifest he signed said the destination was Denver. The signing was done using in part some method of encryption. Acme wrote bad record 130 to the blockchain in FIG. 13.

This record says symbolically “/ABC/”. This means that the record has the signature of an employee of ABC. As well as the signature of Acme. Both signatures can be verified programmatically. The record also says “LA→Denver” to show the purported route.

While the payload went to the correct destination, the problem now remains of how to correct the blockchain. Item 131 is the corrected record. It is signed by Acme and ABC. Likely the latter signature might be not of the ABC driver but of someone higher up in ABC. The record says “LA→Phoenix”. It has the command to replace the earlier record.

This describes how a record is signed by 2 parties. It does not preclude ABC writing its own record, without a signature by Acme, that said LA→Denver. In this case ABC would correct it itself, using the methods of the earlier sections.

Another case is where separately Acme and ABC each wrote a record, signed only by itself. To correct, both firms would write new records, only self signed, containing a replace command.

7: Referring to Another Author's Record;

Thus far we looked at where a record is corrected by the author in a later record. This might be the most common case, and in general the author would be the most reliable person to do so. There is a simple generalisation to when a record is written by a firm's employee and then corrected by another employee. This handles cases including but not limited to—a) where the first employee left the firm; b) the first employee was suspected of deliberately falsifying the record; c) the second employee is higher up the chain of command and can overrule the first employee.

The previous sections used examples of blockchains in logistics/supply chain.

More broadly, consider when a first record is written to the blockchain by Jill. Here she might be acting for herself. The record could be original intellectual property that she wrote, like a poem, a song (lyrics and music), a tune (just music), an essay, a blueprint of an electrical circuit or the plans of a building. The material could be entirely in the record. Or parts or most or all of it might be stored external to the record and blockchain. The record having a link (like an URL or URI) to the external storage.

Here the blockchain need not be specialised to logistics. It can be permissioned or not. But we require that the identity of a person who writes to the blockchain be known or can be deduced from the record. Also, the content of the record can be read, or listened to in the case of music, or viewed in the case of video. We take this to include cases where the record has a link to the full content stored outside the blockchain. We include cases where the reader or viewer has to pay to unlock the content. The mechanism of payment need not involve paying a cryptocurrency.

An important case of commenting on another author's blockchain record is where the commentator is a government or regulatory body, like the US SEC or FBI. It writes a comment about an earlier record Phi written by, for example, a suspected scamster. The current record could have a signature of the regulator. The record can include a summary of evidence and a recommended Call To Action (CTA). The CTA might be—“ignore bad record” with the id of Phi. The regulator record can have a link (eg. URI) to external websites giving more details and evidence.

There might be competing narratives by supporters of the purported scamster, who write records advocating that Phi is good. An analysis program scanning the blockchain can find all commentary records on Phi. It can act akin to a search engine that finds webpages linking to a given page Rho. The search engine uses the reputations of the linking webpages to reach an overall assesment of Rho. Likewise the blockchain analysis can do so for Phi. It can give credence and higher weight to certain governments.

The current record could have links specifically to a court decision. The decision might be against a defendant (person or firm). That defendant (or an employee) wrote a record Kappa to the blockchain. The current record could cite the external court decision in support of a command “delete Kappa”. Or less harshly, a command “dubious Kappa”. Here “dubious” means a record should be treated as low credibility.

In related ways, a court might order that its decision might in part include writing a command record to a read-only blockchain. This record would have commands impacting earlier records written by a party involved with a case that was just decided by the court. So if the court found that Acme was guilty of fraud over a certain set of transactions written to the blockchain, the command record would have commands altering or deleting those transactions. And possibly including or appending other transactions judged by the court to be valid. By the court writing (and being able to do so) that record, with the court as author being verifiable, the record might have high credibility.

The analysis can change the credibility of an organisation as a function of the time when the organisation wrote comments. For example, a police agency might have been issuing faulty or corrupt comments during a period when its government was under the control of a given party. For comments made in this period, that refer to other records in the blockchain written by third parties, the analysis might ignore outright. But in a later time period, when the government changed and the new administration is considered more professional, the analysis could attach more credibility to the (negative) comments made about other records.

8: Sidechain;

Sidechains are used with some blockchains. The basic idea is that there is a parent blockchain. A sidechain usually starts with a (smart) contract that locks certain assets on the blockchain, so that the ownership of those assets cannot change. The sidechain can be a blockchain in its own right. This is a usual condition on the sidechain in the prior art.

Or the sidechain might simply be a set of interactions between parties that happens outside the main (or only) blockchain. During those sidechain interactions, the ownership of the assets might shift between the parties. At the end of the sidechain is a final allocation of the assets between the parties. Typically this differs from the initial allocation, and this is largely the point of the sidechain. The contract on the parent is unlocked and the new asset allocation is published to the parent.

In this sidechain, the assets are usually amounts of the coin or token associated with the (parent) blockchain. In the prior art, there appears to be no discussion of a sidechain being used when the parent blockchain has no currency. But as we suggested, a private (permissioned) blockchain could run without any such currency.

In this case, one possible novelty of this section is the use of sidechains with a private blockchain, to handle errors in the parent blockchain. There is no change of state per se in the latter. This obviates the need for a contract to freeze the state of the ownership of a quantity of currency. No contract also removes a source of error. A contract is computer code, and there is a chance of error.

Another novelty of this section is to show that a sidechain can be useful even when the parent blockchain does not use a currency.

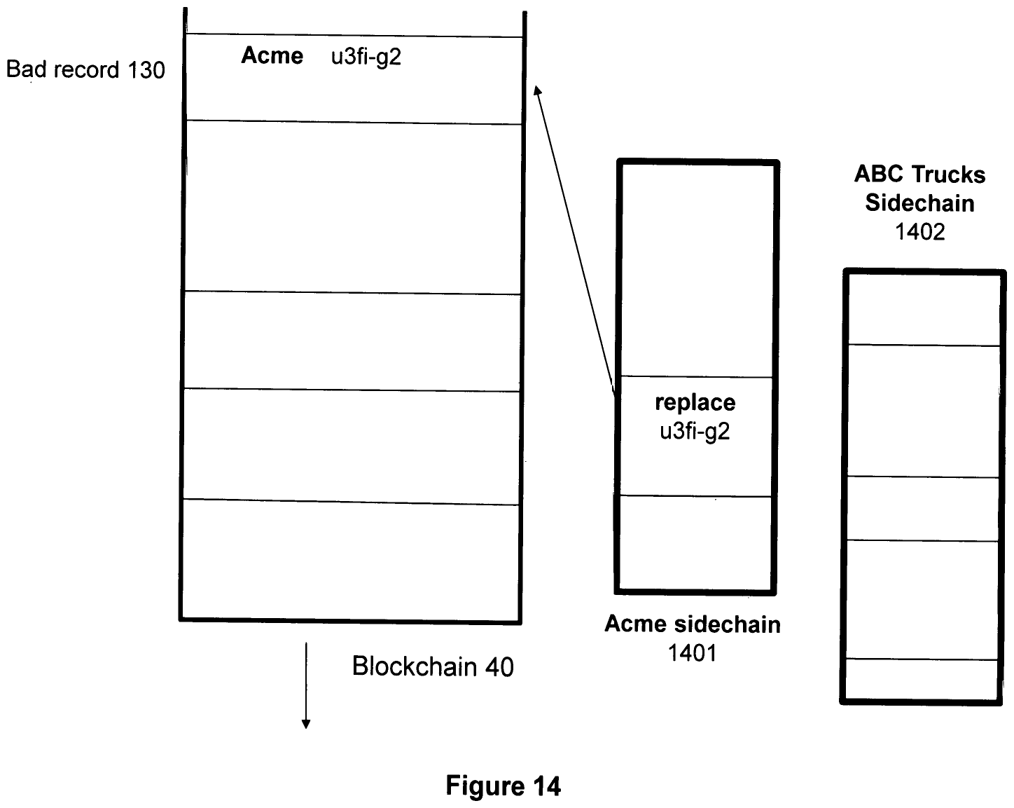

FIG. 14 shows blockchain 40 with bad record 130, written by Acme. The blockchain lets Acme, an authorised user who runs a node, make sidechain 1401. The sidechain can only be written to by Acme, and possibly by an admistrator for the blockchain organiser. The sidechain does not have to be a blockchain—ie. where the sidechain can only be altered by appending records. The sidechain could be implemented as any type of database. Also, the sidechain does not have to be distributed across several nodes. Though in practise it might, for redundancy and to speed up response to queries.

And if sidechain 1401 is copied across nodes, those nodes need not be all the nodes of the blockchain. It might be a subset. How that subset is chosen can be a policy of the blockchain. For example, the subset could be chosen randomly. The subset could be chosen using geographic criteria. Perhaps distribute the subset geographically such that query response times are minimised. Akin to how a Content Distribution Network might pick the locations of its servers. Another case might be if Acme runs several nodes, to just put the sidechain on Acme's nodes, since it is the author of the sidechain.

Also, some nodes of the sidechain need not be nodes of the blockchain.

Instead of Acme writing records with commands to the main blockchain, now it writes some or all of them to sidechain 1401. One benefit is that the blockchain is smaller and reduces the computational and storage requirements on the nodes.

If the sidechain is not a blockchain, then Acme can edit the sidechain. If Acme writes a command to the sidechain and later wants to alter or remove the command, it can.

Acme's sidechain can have a start time, when the sidechain is made. It may or may not have an end time—the time of the last record. In FIG. 14, sidechain 1401 is implicitly shown as having a stand and end time. But just as blockchain 40 is implicitly shown as extending indefinitely into the future (indicated by the down arrow showing the direction of increasing time), so too might a sidechain.

Other firms in the blockchain can have their own sidechains. ABC Trucks runs sidechain 1402, for example.

The blockchain could have a policy that editing commands be restricted to sidechains. Or not—so that some commands will be on the blockchain and others on sidechains.

FIG. 3 described how the Talmud was considered the oldest prior art for this submission. For a blockchain with several associated sidechains, the reader can appreciate how this maps 1-1 with FIG. 3.

A sidechain could have records that are not editing commands. For example, a sidechain could store data that the author does not want or cannot have on the blockchain. The latter might have a maximum size of a record, and the data exceeds that.

A sidechain might be run by several parties. There was an earlier example where a record on the blockchain was signed by 2 parties because they were involved in a shipping event that was wrongly recorded. So both parties had to sign off on a record to correct an earlier record. This can now be shifted to a sidechain run by both.

Or it might be written to a blockchain run by only one of the parties. The record could still be signed by both parties. That one of the signatories is the owner of the sidechain is the enabler of the writing of the record.

A sidechain might be run not primarily by a single party, but by the blockchain organisation itself. It might ask or require that certain type of data or records be put into the sidechain. This could include commands that correct records on the blockchain.

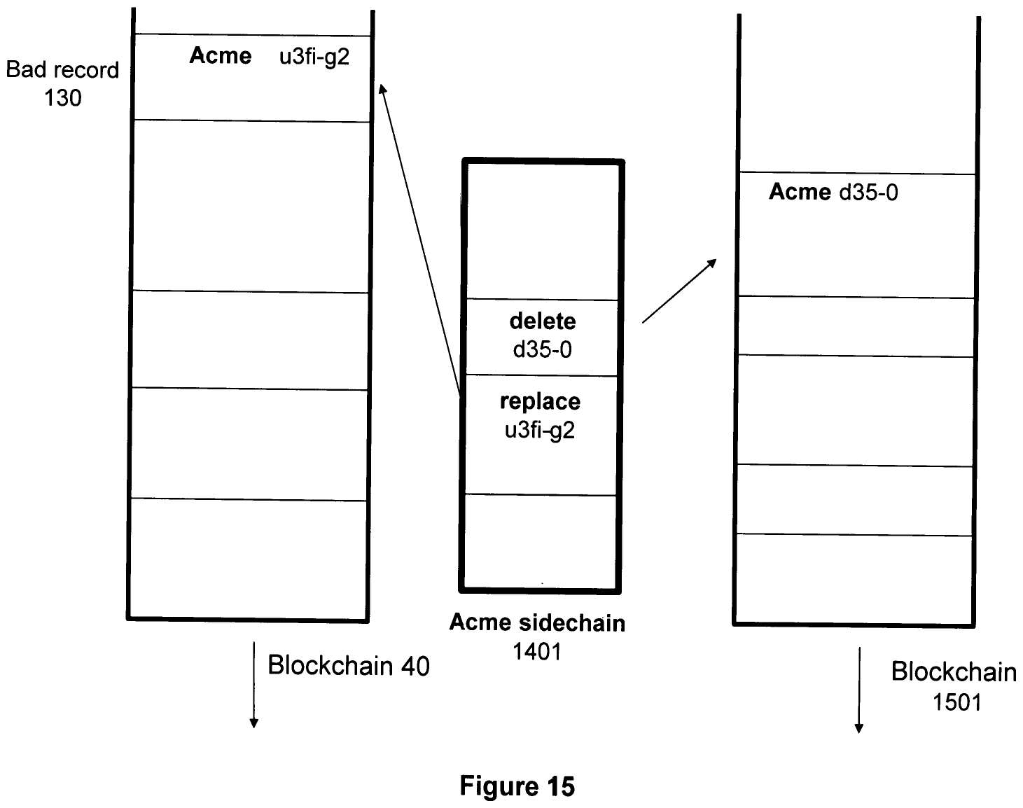

FIG. 15 shows a sidechain 1401 that is a sidechain of 2 blockchains—40 and 1501. The sidechain is run by one firm, Acme. If Acme writes records to the 2 blockchains, it might be convenient for Acme to consolidate its command records into 1 sidechain. The figure shows sidechain 1401 having a record that is a delete operation on a record d35-0 written by Acme in blockchain 1501.

Though in general the sidechain might be able to be written to by several parties. A given party need not be required to be able to write to both blockchains.

FIG. 15 allows another possibility. Control logic in a sidechain record can read a record (or several) in blockchain 40. Based on an analysis of the blockchain record (or records), the logic of the sidechain record can manipulate one or more records in blockchain 1501. Of course, here as elsewhere in this submission, manipulate means altering a copy or subset of the blockchain in memory, and not the original read only blockchain.

The above discussion in this section centred on a blockchain with no internal currency. If such a currency exists, the discussion can be applied to that blockchain.

9: Blockchain Policies;

Earlier we described various commands (like delete and replace) that could be put into a blockchain record, to correct earlier records. The blockchain could define a standard syntax of commands. Then it might suggest that firms wanting to correct their records use this syntax. The blockchain could mandate this as a requirement. Or it could make it optional. In the latter case, a given firm might define its own set of commands. Different firms decide whether to use the standard blockchain commands or their own.

This is not exclusive or. A firm might use the standard blockchain commands, and find that it is useful to define its own commands, specific to the types of data it writes in its records.

Why would a firm correct its faulty records? In a permissioned blockchain, it could be required to by the firm running the blockchain or supply chain. There might be, the equivalent of the Duty of Candor for patent applicants, imposed by the head firm on its suppliers. The “Duty” could be justified by the benefits of having an overall correct ledger. So that the firms and outside auditors or authorities could programmatically analyse the blockchain for auditing purposes.

10: Rewritable Blockchain;

All earlier sections described an append-only blockchain. Now suppose the blockchain is rewritable. Remarks made earlier about commands still pertain. But an extra possibility arises. Periodically the blockchain might want to alter the ledger. Because it is vital to maintain a consistent ledger across the nodes, one way is for the blockchain to temporarily refuse to accept new records while the nodes act. These nodes need not be all the nodes of the blockchain. Some blockchains could have a subset of “fat” nodes, each holding a full ledger. While other “thin” nodes might only have a subset of the ledger.

The fat nodes can then operate and alter it. For example, the command records can be used and then deleted from the ledger. If a command record says, for example, delete an earlier record Alpha, then Alpha is deleted and then so too is the command record.

If a command record says delete earlier record Alpha and record Beta, then Alpha and Beta are deleted and so too is the command record.

If a command record says replace earlier record Alpha with the data in the command record, then this is done. The altered record that replaces Alpha might have the time stamp of Alpha. The command record is then deleted.

If the reader goes back to the various examples of command records in the earlier sections, then similar actions can be taken to change the ledger.

One merit of these actions is to clean up the ledger. To delete faulty records. Another merit is to reduce the size of the ledger. Which reduces the memory footprint of the ledger and concomitant storage and transmission costs.

When a command is used to operate on an earlier record Alpha, there may need to be a policy around a “statute of limitations” as to the longest time after the time stamp of Alpha, wherein a command record can be made that operates on Alpha or on a command record that in turn recursively and ultimately references Alpha. For example, suppose after Alpha is written, a command Beta is written that says delete Alpha. Then 2 days later, a command Delta is written that says delete Beta. At this point, if the blockchain now alters the existing ledger records, then Delta cancels Beta and Alpha remains.

But suppose instead the blockchain does not do this. And 1 day after Delta, a command Gamma is written that says delete Delta. If the blockchain now cleans up the ledger, then the operations (from latest to earliest) Gamma→Delta→Beta reduce to Beta=“delete Alpha”, which then operates on Alpha. Of these 4 records, all are removed.

In other words, without some maximum cutoff time for a record, then future commands can arbitrarily alter it or not. So when the blockchain acts to clean up the ledger, it could have a policy of a maximum cut off time.

But for a long ledger and with intricate records and commands, it might be computationally infeasible to have that cut off time and to check it against existing records.

A simpler alternative is for records to be altered only if the records were written at least, say, 24 hours before the current time when the blockchain is doing this cleanup. So a node will only look at nodes starting 24 hours earlier, and going backwards thru the ledger to perform any commands.

This also gives rise to another possibility. If the blockchain has some nodes with a full ledger and thin nodes, then the fat nodes can do the cleanup while the thin nodes continue to accept new nodes. When the fat nodes are done, they update with the new nodes (if any) from the thin nodes. There might likely be another flow of data from the fat to the thin nodes. This has to do with fat nodes having new hashes because they altered and deleted various nodes.

Since the very point of the hashes is to chain all the records, then a thin node which, say, only has the most recent records sent in the last 48 hours, would need a starting hash that represents all the records before 48 hours. That has to come from a fat node. The thin node would also need or perhaps it could compute the hashes representing the records between 48 hours and 24 hours, that were output by the fat nodes.

If carefully done, this maintains the uptime of the overall blockchain. And assuming that the thin nodes have the memory and processing ability to hold new incoming records while the fat nodes are cleaning up the old records.

Another case where command records can be used to rewrite the blockchain is when the organisation running the blockchain decides to archive all records made before a certain time, say 1 Feb. 2020, where the present date is after 2023 for example. It could do this to reduce the amount of data needed to be held by the nodes. So on say 1 Mar. 2023, it freezes the blockchain from accepting new records. It spins off the records written before 1 Feb. 2020 into archival storage. And the ledger now starts with records written after than time.

One choice is that for the archived records, any command records are run to reduce the size of what is held in archive. A nuance is where 2 or more copies of the archive are held. One copy might have no command records run—this is the “full” copy. The other copies have the commands run to make smaller storage.

Independent of what is done with the archive, the organisation can also pursue similar actions with the records from 1 Feb. 2020 to 1 Mar. 2023. It runs command records to simplify (reduce) the size of the “active” or current ledger.

From remarks made in earlier sections, there can be the possibility of questions about the transition of 1 Feb. 2020. There might be commands written after that date, that refer to records written before that date. In response, finer grained policy can be done to handle these cases.

Finally, for a “final” ledger from 1 Feb. 2020 to 1 Mar. 2023 (=the present), hashes can be made to commingle the records and the blockchain can be reactivated.

We claim:

1. A method of an analysis program reading records from a blockchain; the program reading a record, Alpha, containing a first command; the first command referring to an earlier record, Beta, in the blockchain; the program reading Beta from the blockchain into a memory of the program; the program performing the first command on Beta; the program putting a result into an amended blockchain held in the memory of the program.

2. The method of claim 1, where the first command is a delete operation; the program not writing Beta to the amended blockchain; the program not writing Alpha to the amended blockchain.

3. The method of claim 1, where the first command is a replace operation; the program replacing the data in the copy of Beta held by the program with the data in Alpha; the program writing Beta to the amended blockchain; the program not writing Alpha to the amended blockchain.

4. The method of claim 1, where the first command is an append operation; the program appending the data in Alpha to the copy of Beta held by the program; the program writing Beta to the amended blockchain; the program not writing Alpha to the amended blockchain.

5. The method of claim 1, where the first command is a prepend operation; the program prepending the data in Alpha to the copy of Beta held by the program; the program writing Beta to the amended blockchain; the program not writing Alpha to the amended blockchain.

6. The method of claim 1, where Alpha contains a second command; the second command referring to an earlier record Gamma in the blockchain; Beta differing from Gamma; the program reading Gamma from the blockchain into the memory of the program; the program performing the second command on Gamma; the program writing the result into the amended blockchain.

7. The method of claim 1, the first command having computer code; the program running the code on Beta; the program writing a Beta result to the amended blockchain.

8. The method of claim 1, the first command having the identifiers of several records, including the identifier of Beta; the program reading records from the blockchain; where if a record has an identifier in the set of identifiers of the first command, the program runs the code on the record; the program writing the result to the amended blockchain.

9. The method of claim 1, the first command having a start time and an end time; the program reading records from the blockchain; where if a record has a timestamp after the start time and before the end time, and if the record was written by the same author who wrote Alpha, the program runs the code on the record; the program writing the result to the amended blockchain.

10. The method of claim 1, the first command having a first instance of computer code; Alpha having a Universal Resource Indicator (URI) link to a second instance of computer code; the URI pointing to a destination different from the blockchain; the program running the first instance and the second instance against Beta; the program writing the Beta result to the amended blockchain.

11. A method of an analysis program reading records from a blockchain; the program reading a record, Alpha, containing a command; the first command referring to a future record, Beta, in the blockchain; the program reading Beta from the blockchain into a memory of the program; the program performing the command on Beta; the program putting a result into an amended blockchain held in the memory of the program.

12. A method of an analysis program reading records from a blockchain; the program reading a record, Alpha, containing a first command; Alpha having a signature of an author of Alpha, and a signature of another entity; the first command referring to an earlier record, Beta, in the blockchain; Beta having the signature of the other entity; the program reading Beta from the blockchain into a memory of the program; the program performing the command on Beta; the program putting a result into an amended blockchain held in the memory of the program.

13. The method of claim 12, where the first command is a delete operation; the program not writing Beta to the amended blockchain; the program not writing Alpha to the amended blockchain.

14. The method of claim 12, where the first command is a replace operation; the program replacing the data in the copy of Beta held by the program with the data in Alpha; the program writing Beta to the amended blockchain; the program not writing Alpha to the amended blockchain.

15. The method of claim 12, where the first command is an append operation; the program appending the data in Alpha to the copy of Beta held by the program; the program writing Beta to the amended blockchain; the program not writing Alpha to the amended blockchain.

16. The method of claim 12, where the first command is a prepend operation; the program prepending the data in Alpha to the copy of Beta held by the program; the program writing Beta to the amended blockchain; the program not writing Alpha to the amended blockchain.

17. A method of an analysis program reading a first blockchain; the first blockchain having a sidechain; the program reading the sidechain; the sidechain having a record, Alpha, containing a command; the command referring to a record, Beta, in the first blockchain; the program reading Beta from the first blockchain into a memory of the program; the program performing the command on Beta; the program putting a result into an amended first blockchain held in the memory of the program.

18. The method of claim 17, with all the records in the sidechain being written by the same author.

19. The method of claim 17, with the sidechain being a sidechain of a second blockchain; the sidechain having a record, Delta, containing a command; the command referring to a record, Gamma, in the second blockchain; the program reading Gamma from the second blockchain into a memory of the program; the program performing the command on Gamma; the program putting a result into an amended second blockchain held in the memory of the program.
